(19) United States
(12) Patent Application Publication
(10) Pub. No.: US 2013/0160740 A1
(43) Pub. Date: Jun. 27, 2013

(54) ENGINE AND ENGINE OPERATING MACHINE INCLUDING THE SAME

(71) Applicants: Junichi Kamimura, Ibaraki (JP); Takuhiro Murakami, Ibaraki (JP); Naoto Ichihashi, Ibaraki (JP); Kentarou Kanaya, Ibaraki (JP)

(72) Inventors: Junichi Kamimura, Ibaraki (JP); Takuhiro Murakami, Ibaraki (JP); Naoto Ichihashi, Ibaraki (JP); Kentarou Kanaya, Ibaraki (JP)

(73) Assignee: HITACHI KOKI CO., LTD., Tokyo (JP)

(21) Appl. No.: 13/695,239

(22) PCT Filed: Apr. 28, 2011
(86) PCT No.: PCT/JP2011/060797

§ 371 Date: Mar. 11, 2013

(30) Foreign Application Priority Data
Apr. 30, 2010 (JP) 2010-105914

(51) Int. Cl. F02M 17/00

(52) U.S. Cl. CPC F02M 17/00
USPC 123/445

(57) ABSTRACT

An engine including: a cylinder block formed with a cylinder bore; a carburetor including, a fuel storage portion that stores fuel supplied from a fuel tank and supplies the fuel to a suction path, and a fuel discharge path that discharges fuel overflowed from the fuel storage portion; a starting fuel supply device including, a starting fuel storage chamber that is provided on a fuel route defined by the fuel tank and the carburetor and stores a predetermined amount of fuel, a fuel delivery portion that delivers the fuel to a starting fuel supply path connected to the suction path or the cylinder bore, and a fuel return path that discharges the fuel overflowed from the starting fuel storage chamber; and a notifying portion that visually notifies that the starting fuel storage chamber is filled with fuel.

### TECHNICAL FIELD

Aspects of the present invention relate to an engine, particularly, an engine suitable for a portable engine operating machine such as a brush cutter or a chainsaw.

### BACKGROUND ART

In order to facilitate the starting of an engine, for example, as shown in JP-UM-B-H06-049895, there is known an engine which includes a starting fuel supplier that supplies a carburetor with a suitable amount of starting auxiliary fuel to increase a fuel concentration of mixed air.

### SUMMARY OF INVENTION

### Technical Problem

Incidentally, the aforementioned engine is provided with a primary pump for supplying a carburetor with fuel, at an upstream of the starting fuel supplier. For this reason, in some cases, even if the primary pump is operated in the process of the starting of the engine and fuel reaches the primary pump, fuel is not supplied to the starting fuel supplier. In this case, it is difficult to sufficiently supply the carburetor with the starting auxiliary fuel, and it is difficult for the engine to be started in spite of the starting fuel supplier being operated.

Accordingly, aspects of the present invention provide an engine capable of increasing the reliability of the starting fuel supplier to more easily perform the starting operation, and an engine operating machine including the same.

### Solution to Problem

According to an aspect of the present invention, there is provided an engine including: a cylinder block formed with a cylinder bore; a carburetor including, a fuel storage portion that stores fuel supplied from a fuel tank via a fuel supply path and supplies the fuel to a suction path, and a fuel discharge path that discharges fuel overflowed from the fuel storage portion; a starting fuel supply device including, a starting fuel storage chamber that is provided on a fuel route defined by the fuel tank and the carburetor and stores a predetermined amount of fuel, a fuel delivery portion that delivers the fuel in the starting fuel storage chamber to a starting fuel supply path connected to the suction path or the cylinder bore, and a fuel return path that discharges the fuel overflowed from the starting fuel storage chamber; and a notifying portion that visually notifies that the starting fuel storage chamber is filled with fuel.

According to another aspect of the present invention, there is provided an engine operating machine, including the above-described engine.

### Advantageous Effects of Invention

According to the engine of the present invention, since there is provided a notifying portion notifying that a fuel storage chamber of a starting fuel supply device is filled with fuel, it is possible to increase the reliability of the starting fuel supply to more easily perform the starting operation.

### BRIEF DESCRIPTION OF THE DRAWINGS

FIG. 1 is a rear side view of a brush cutter on which an engine according to a first exemplary embodiment of the invention is mounted;

FIG. 2 is an enlarged cross-sectional view of an engine portion as shown in FIG. 1;

FIG. 3 is an enlarged cross-sectional view of a starting fuel supply device as shown in FIG. 2;

FIG. 4 is a cross-sectional view taken from line IV-IV of FIG. 3;

FIG. 5 is an enlarged perspective view of the starting fuel supply device as shown in FIG. 2;

FIG. 6 is an enlarged cross-sectional view that shows a state in which a rotation portion of the starting fuel supply device as shown in FIG. 2 is rotated from the state as shown in FIG. 3 by 180 degrees;

FIG. 7 is a cross-sectional view taken from line VII-VII of FIG. 6;

FIG. 8 is an enlarged cross-sectional view corresponding to FIG. 3 that shows a modified example of the starting fuel supply device as shown in FIG. 2;

FIG. 9 is a cross-sectional view taken from line IX-IX of FIG. 8;

FIG. 10 is an enlarged cross-sectional view that shows a state in which a rotation portion of the starting fuel supply device as shown in FIG. 8 is rotated from the state as shown in FIG. 8 by 90 degrees;

FIG. 11 is a cross-sectional view taken from line XI-XI of FIG. 10;

FIG. 12 is an enlarged cross-sectional view corresponding to FIG. 3 that shows a modified example of the starting fuel supply device as shown in FIG. 2;

FIG. 13 is a cross-sectional view taken from line XIII-XIII of FIG. 12;

FIG. 14 is an enlarged cross-sectional view that shows a state in which a rotation portion of the starting fuel supply device as shown in FIG. 12 is rotated from the state as shown in FIG. 12 by 90 degrees;

FIG. 15 is a cross-sectional view taken from line XV-XV of FIG. 14;

FIG. 16 is a cross-sectional view corresponding to FIG. 13 that shows a modified example of a rotation portion of a starting fuel supply device as shown in FIG. 12;

FIG. 17 is a perspective view of a chainsaw on which an engine according to a first exemplary embodiment of the invention is mounted;

FIG. 18 is a rear side view of a brush cutter on which an engine according to a second exemplary embodiment of the invention is mounted;

FIG. 19 is an enlarged cross-sectional view of an engine portion as shown in FIG. 18;

FIG. 20 is a cross-section view taken from line XX-XX of FIG. 19;

FIG. 21 is an enlarged cross-sectional view of a decompression device portion as shown in FIG. 20;

FIG. 22 is an enlarged cross-sectional view of a decompression device portion that shows a state in which an operation button of a decompression device as shown in FIG. 20 is pushed;

FIG. 23 is an enlarged cross-sectional view of a decompression device portion that shows a state in which an operation button of a decompression device is released from the state as shown in FIG. 22;

FIG. 24 is a perspective view of a chainsaw on which an engine according to a second exemplary embodiment of the invention is mounted;

FIG. 25 is a rear side view of a brush cutter on which an engine according to a third exemplary embodiment of the invention is mounted;

FIG. 26 is an enlarged cross-sectional view of an engine portion as shown in FIG. 25;

FIG. 27 is an enlarged cross-sectional view of a starting fuel supply device portion as shown in FIG. 26;

FIG. 28 is a perspective view of a chainsaw on which the engine according to the third exemplary embodiment of the invention is mounted; and

FIG. 29 is a perspective view of a brush cutter on which the engine according to any one of the first to third exemplary embodiments of the invention is mounted.

### DESCRIPTION OF EMBODIMENTS

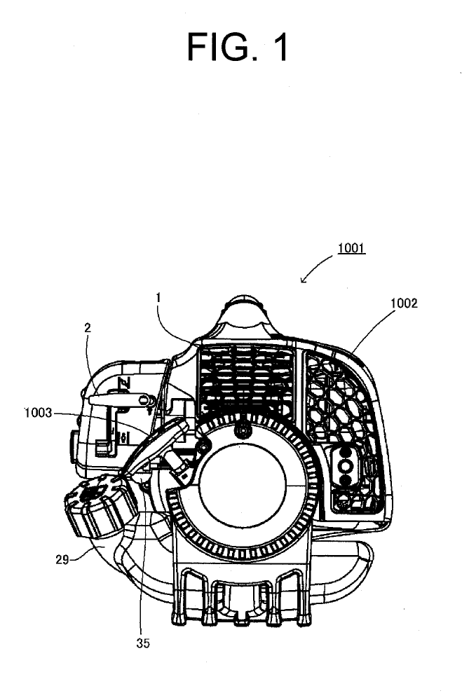

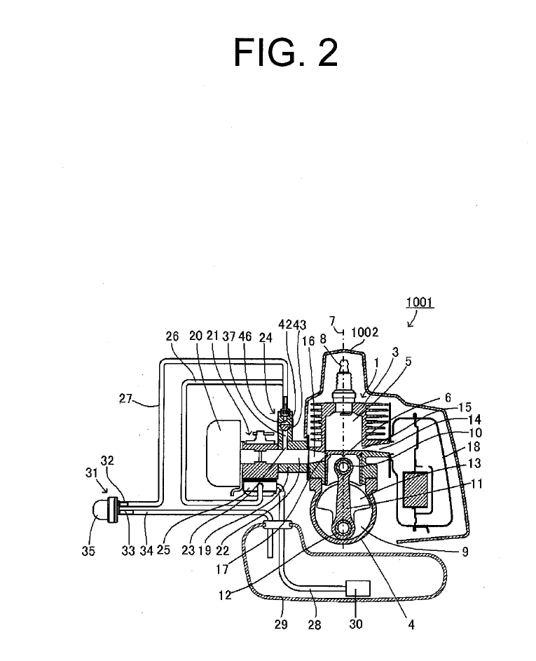

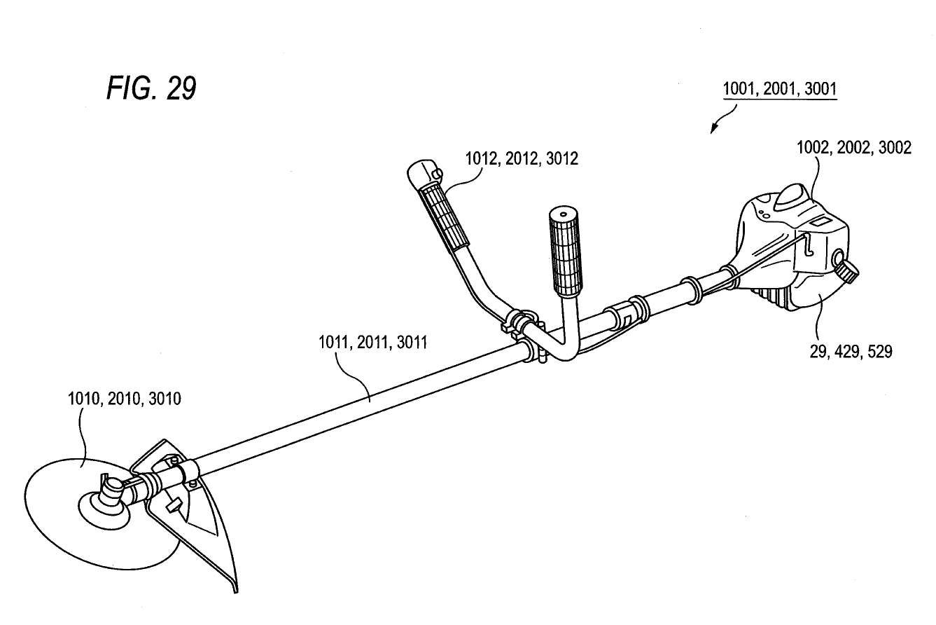

Hereinafter, a first exemplary embodiment of the invention will be described based on FIGS. 1 to 17 and 29. As shown in FIG. 29, a brush cutter 1001, on which a small two cycle engine 1 (hereinafter, referred to as engine) suitable for being mounted onto a portable engine operating machine is mounted, is described. The brush cutter 1001 includes an engine case 1002 with an engine 1 (see FIGS. 1 and 2) accommodated therein, an operation rod 1011 protruding from the engine case 1002, to which a rotation knife 1010 is attached at a distal end thereof, and a starter handle 1003 for starting the engine 1. The output of the engine 1 is supplied to the rotation knife via a drive shaft inserted into the operation rod. A worker grasps a handle 1012 attached to the operation rod 1011 to operate the brush cutter 1001. Furthermore, a fuel supply lever 2 for supplying the starting auxiliary fuel and an operation portion 35 of a primary pump, which sucks fuel from a fuel tank 29 to supply a carburetor (not shown) with fuel, are provided so as to protrude from the engine case 1002.

As shown in FIG. 2, a crank case 4 is attached to a cylinder block 3 of the engine 1. In a cylinder bore 5 of the cylinder block 3, a piston 6 is moved up and down (up and down in FIG. 2) in an axial 7 direction of the cylinder bore 5. In FIG. 2, the piston 6 is situated in a bottom dead center. An ignition plug 8 is attached to a top portion above the cylinder bore 5. The cylinder bore 5 connects with a crank chamber 9 in the crank case 4 at a lower part thereof. The piston 6 connects with a crank shaft 12 which is rotatably supported on the crank case 4 via a piston pin 10 and a connecting rod 11. A crank weight 13 is attached to the crank shaft 12.

In an inner periphery wall of the cylinder bore 5, an exhaust opening 15 connecting with an exhaust port 14, a suction opening 17 connecting with a suction port 16, and a scavenging opening (not shown) connecting with a scavenging path (not shown), are opened. A muffler 18 connects with the cylinder block 3 so as to communicate with the exhaust port 14. Furthermore, an insulator 19 connects with the cylinder block 3 so as to communicate with the suction port 16, and a carburetor 21 linked to an air cleaner 20 connects with the insulator 19.

In an upper part of the axial 7 direction of the suction path 22 of the insulator 19, that is, in a position becoming the upper part of the suction path 22 in the state in which the brush cutter 1001 is placed on the ground, a through-hole 23 is formed. Moreover, a starting fuel supply device 24 connects with the upper part of the axial 7 direction of the insulator 19 so as to communicate with the through-hole 23. A first fuel path (a fuel discharge path) 26, which discharges fuel overflowed from a fuel storage portion 25 of the carburetor 21, and a second fuel path (a fuel return path) 27 are connected to the starting fuel supply device 24. Furthermore, an end of a third fuel path (a fuel supply path) 28 connects with the fuel storage portion 25 of the carburetor 21, and the other end of the third fuel path 28 connects with a fuel suction port 30 in the fuel tank 29. Moreover, the second fuel path 27 connected to the starting fuel supply device 24 connects with a first fuel absorption port 32 of a primary pump (notifying portion) 31. A fourth fuel path (a return path) 34 connected to the fuel tank 29 connects with a fuel discharge port 33 of the primary pump 31. In addition, the primary pump 31 is provided with an operation portion 35 that is elastically deformable and transmits light. The operation portion 35 absorbs fuel from the fuel absorption port 32 into an inner portion thereof and discharges the fuel absorbed in the inner portion thereof from the fuel discharge port 33 by repeating compression deformation and elastic restoration.

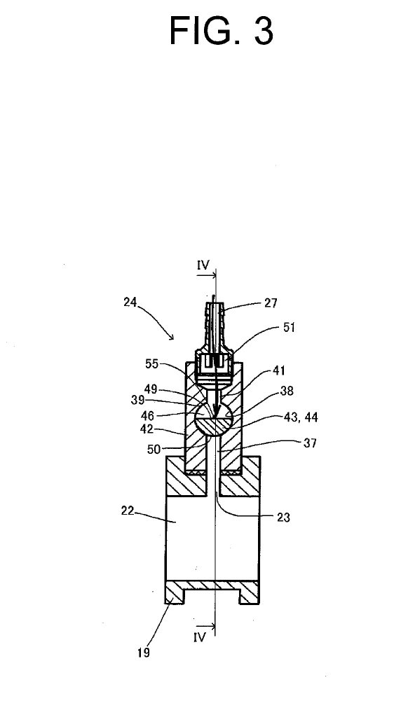

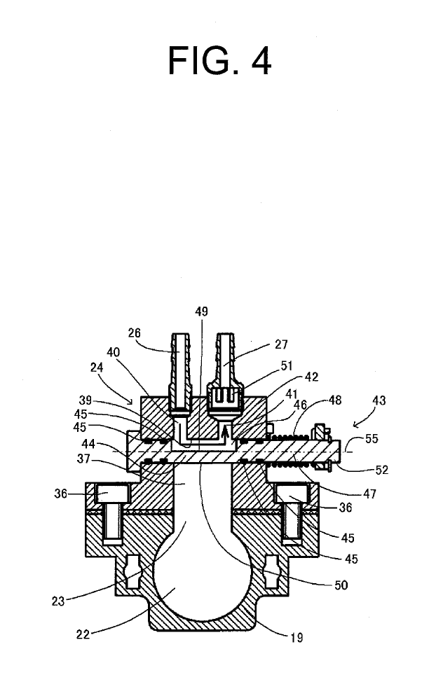

As shown in FIG. 3, the starting fuel supply device 24, which is attached to the upper part of the insulator 19 by a bolt 36 (see FIG. 4), includes a housing that includes: a starting fuel supply path 37 that connects with the upper end of the through-hole 23 and extends upwards, a cylindrical hole portion 39 that has an inner periphery wall 38 having an approximately circular cross-section surface and that connects with the upper end of the starting fuel supply path 37, a fuel inflow hole 40 (a fuel inflow path, see FIG. 4) that connects with the upper part of the hole portion 39 and to which the first fuel path 26 (see FIG. 4) is connected, and a fuel outflow hole 41 (fuel outflow path) that connects with the upper part of the hole portion 39 and to which the second fuel path 27 is connected. Further, the starting fuel supply device 24 includes an approximately cylindrical rotation portion (fuel delivery portion) 43 which has a cross-sectional surface shape of an approximately partial semicircle or a fan shape and is rotatably supported along an inner periphery wall 38 of the hole portion 39. When viewing in an rotation axis 55 direction of the rotation portion 43, a connection position between the inner periphery wall 38 of the hole portion 39 and the fuel inflow hole 40 and the fuel outflow hole 41, and a connection position between the inner periphery wall 38 and the starting fuel supply path 37 are disposed so as to interpose the rotation axis 55 of the rotation portion 43 therebetween and face each other, that is, so as to be situated on the circumference of the inner periphery wall 38 in positions separated by 180 degrees.

As shown in FIG. 4, the rotation portion 43 extends through the hole portion 39 of the housing portion 42. Regarding a longitudinal direction of the rotation portion 43, the rotation portion 43 has a semicircle portion 44 with an approximately semicircular shape having a length that slightly exceeds the starting fuel supply path 37 of the hole portion 39. In the state in which the rotation portion 43 is assembled to the housing portion 42, regarding the longitudinal direction of the rotation portion 43, the position of the semicircle portion 44 approximately coincides with a position where the starting fuel supply path 37 is formed, and approximately coincides with a position where the fuel inflow hole 40 and the fuel outflow hole 41 are formed. Furthermore, O-rings 45 are provided on both ends of the semicircle portion 44. In a state in which the rotation portion 43 is assembled to the housing portion 42, the O-rings 45 support the rotation portion 43 so as to be rotatable against the hole portion 39. The O-rings 45 support the rotation portion such that the semicircle portion 44 is airtight against the hole portion 39, that is, such that fuel does not leak from the portion between the rotation portion 43 and the hole portion 39. Moreover, a starting fuel storage chamber 46, which stores a predetermined amount of fuel, is formed between the hole portion 39 and the semicircle portion 43. The amount of fuel to be stored in the starting fuel storage chamber 46 can be suitably changed by changing the diameter of the hole portion 39 and the size and the shape of the semicircle portion 44 depending on the displacement, the used environment, or the like of the engine 1. For example, the amount of fuel to be stored in the starting fuel storage chamber 46 can be suitably changed by changing the length of the semicircle portion 44 in the longitudinal direction thereof or by changing a center angle of the semicircle portion 44 to make the semicircle portion 44 have a fan-shaped cross-section.

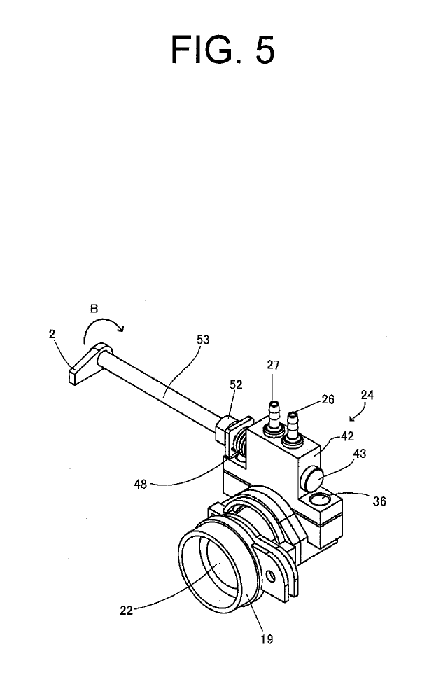

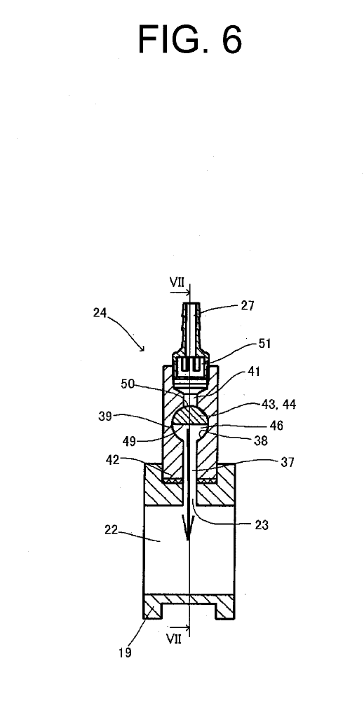

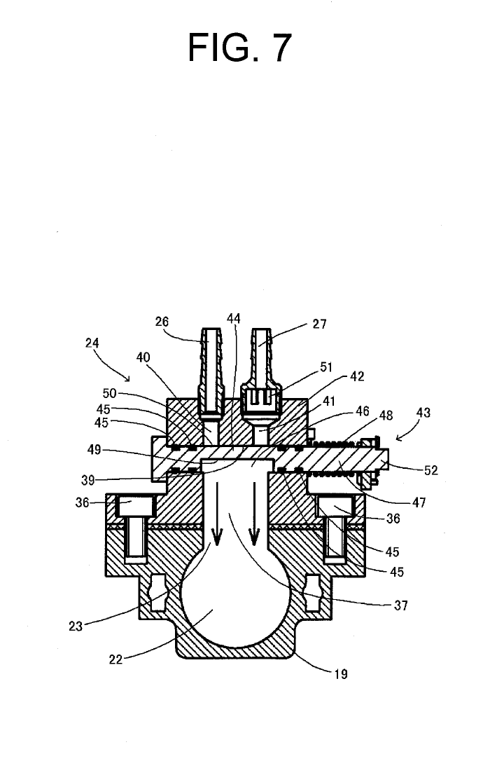

In one (right part in the drawings) protrusion portion 47 of the rotation portion 43 that is protruded from the housing portion 42, there is provided a torsion spring 48 which connects with the housing portion 42 at one end thereof. The torsion spring 48 biases the rotation portion 43 so that the semicircle portion 44 of the rotation portion 43 is maintained in the position of FIG. 4, that is, so that the rotation portion 43 is maintained in a position (second rotation position) where a flat portion 49 of the semicircle portion 44 faces the fuel inflow hole 40 and the fuel outflow hole 41, the starting fuel storage chamber 46 communicates with the fuel inflow hole 40 and the fuel outflow hole 41, and a curved surface portion 50 of the semicircle portion 44 faces the starting fuel supply path 37 to close the starting fuel supply path 37. In addition, between the fuel outflow hole 41 and the second fuel path 27, there is provided a one-way valve 51 which allows fuel to flow from the fuel outflow hole 41 to the second fuel path 27 as shown in FIG. 3 by an arrow. Furthermore, as shown in FIG. 5, an extension shaft portion 53 is attached to the end portion 52 of the protrusion portion 47 of the rotation portion 43. The extension shaft portion 53 is extended from the rotation portion 43 toward the outside of the engine case 1002 (see FIG. 1) concentrically with the rotation portion 43 and is provided with the operation lever 2 protruding from the engine case 1002 at an end portion thereof. The operation lever 2 is rotated in a direction shown in an arrow B. In the state in which the operation lever 2 is not operated, the operation lever 2 is biased by a torsion spring 48 so as to be maintained in the position shown in FIG. 5, whereby the rotation portion 43 is maintained in a second rotation position. When the operation lever 2 is rotated from the position shown in FIG. 5 by 180 degrees in the direction shown by the arrow B against the biasing force of the torsion spring 48, the rotation portion 43 is rotated from the position shown in FIGS. 3 and 4 by 180 degrees. Moreover, as shown in FIGS. 6 and 7, the rotation portion 43 is moved to a position (first rotation position) where the curved surface portion 50 of the semicircle portion 44 faces the fuel inflow hole 40 and the fuel outflow hole 41 to close the fuel inflow hole 40 and the fuel outflow hole 41, and the flat portion 49 of the semicircle portion 44 faces the starting fuel supply path 37 and the starting fuel storage chamber 46 communicates with the starting fuel supply path 37.

According to the engine 1 configured as above, when a worker starts the engine 1, firstly, an operation of pushing the operation portion 35 of the primary pump 31 is performed, thereby absorbing fuel from the fuel tank 29. The fuel absorbed from the fuel suction port 30 of the fuel tank 29 flows into the fuel storage portion 25 of the carburetor 21 through the third fuel path 28. The fuel overflowed from the fuel storage chamber 25 flows from the fuel inflow hole 40 of the starting fuel supply device 24 into the starting fuel storage chamber 46 through the first fuel path 26. The fuel overflowed from the starting fuel storage chamber 46 passes from the fuel outflow hole 41 to the one-way valve 51 and the second fuel path 27, and flows from the fuel absorption port 32 of the primary pump 31 into the operation portion 35. The fuel overflowed from the operation portion 35 returns from the fuel discharge port 33 to the fuel tank 29 through the fourth fuel path 34. A worker operates the primary pump 31 until it is confirmed that fuel flows into the operation portion 35. After confirming that fuel reaches up to the operation portion 35 of the primary pump 31, the worker rotates the operation lever 2 by 180 degrees against the biasing force of the torsion spring 48. When the rotation portion 43 of the starting fuel supply device 24 is rotated from the second rotation position shown in FIGS. 3 and 4 by 180 degrees through this operation and is rotated to the first rotation position shown in FIGS. 6 and 7, the starting fuel storage chamber 46 communicates with the starting fuel supply path 37, and a predetermined amount of fuel in the starting fuel storage chamber 46 flows from the starting fuel supply path 37 into the suction path 22 through the through-hole 23 of the insulator 19. In addition, in the state of placing the brush cutter 1001 on the ground as in the case of starting the engine 1 of the brush cutter 1001, since the starting fuel storage chamber 46 is situated above the starting fuel supply path 37, the through-hole 23 of the insulator 19, and the suction path 22 of the insulator 19, fuel is dropped by gravity and flows into the suction path 22. Furthermore, when a worker releases the operation lever 2, the operation lever 2 is automatically rotated by 180 degrees due to the biasing force of the torsion spring 48, and the rotation portion 43 returns to the second rotation position shown in FIGS. 3 and 4. Moreover, when a worker pulls the starter handle 1007 (see FIG. 1) to start the engine 1, fuel supplied from the starting fuel supply path 37 exists in the suction path 22. For this reason, it is possible to supply the mixed air of a high fuel concentration into the cylinder bore 5, whereby the engine 1 is easily started. Thus, it is possible to reduce the number of operation of the starter handle 1003 to easily perform the starting of the engine 1.

In this manner, since the operation of the operation lever 2 is transmitted to the rotation portion 43 via the extension shaft portion 53, a worker can provide the operation lever 2 and the starting fuel supply device 24 so as to be separated from each other. Thus, the starting fuel supply device 24 can be provided near the suction path 22, whereby it is possible to reliably perform the supply of the starting fuel to the suction path 22. Furthermore, since the starting fuel supply device 24 is provided to the upstream of the primary pump 31 having the operation portion 35, it is possible to easily ascertain that a predetermined amount of fuel exists in the starting fuel storage chamber 46 of the starting fuel supply device 24 by recognizing that fuel reaches the operation portion 35. Thus, by operating the operation lever 2 after recognizing that fuel reaches the operation portion 35, it is possible to reliably transport a predetermined amount of fuel in the starting fuel storage chamber 46 to the suction path 22. As a result, it is possible to more easily perform the starting operation of the engine 1 that uses the starting fuel supply device 24. Moreover, in the case of performing an operation of rotating the operation lever 2 by 180 degrees, the fuel inflow hole 40 and the fuel outflow hole 41 are closed by the curved surface portion 50 of the semicircle portion 44 of the rotation portion 43. Accordingly, unnecessary fuel is not supplied into the starting fuel storage chamber 46, and it is possible to supply the mixed air of a suitably high fuel concentration into the cylinder bore 5, which suppresses an occurrence of a problem that the ignition plug 8 is covered, whereby the starting of the engine 1 can be easily performed. Furthermore, since the operation lever 2 and the rotation portion 43 automatically return to the original position (the state in which the position of the rotation portion 43 is in the second rotation position) by releasing the operation lever 2, the operation of the starting fuel supply device 24 is more easily performed when the engine 1 is started, and the operability in the process of starting is remarkably improved.

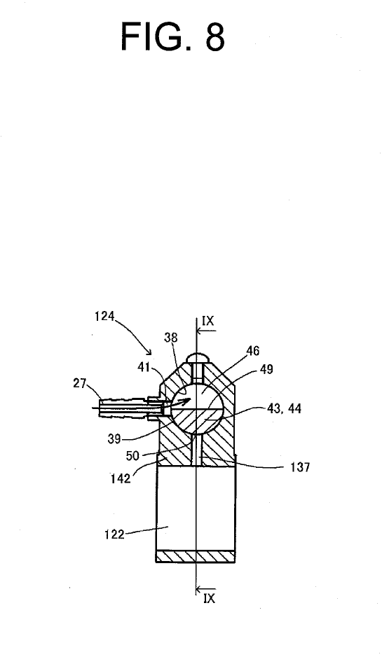

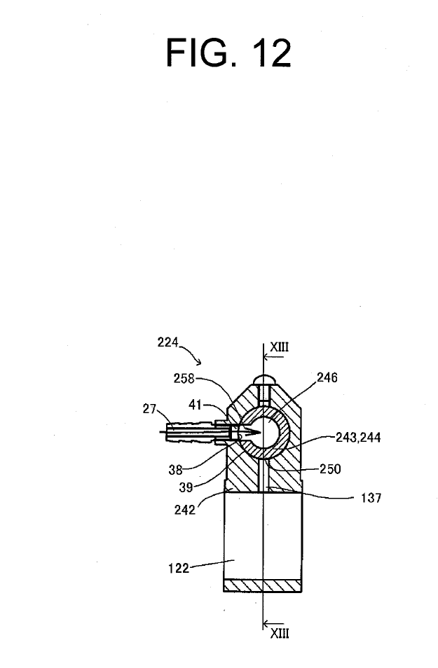

In addition, the starting fuel supply device 24 is not limited to the aforementioned structure, but may be, for example, a starting fuel supply device 124 having the structure shown in FIGS. 8 to 11, and a starting fuel supply device 224 having the structure shown in FIGS. 12 to 16. In addition, in the following description, the same components as the aforementioned starting fuel supply device 24 are denoted by the same reference numerals and the detailed descriptions thereof will be omitted.

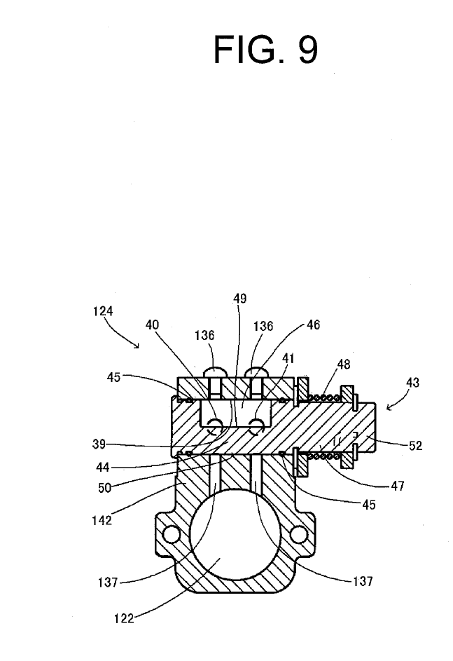

As shown in FIG. 8, the starting fuel supply device 124 is formed so that the extension directions of the fuel inflow hole 40 and the fuel outflow direction 41 form a right angle relative to the extension direction of a starting fuel supply path 137. A suction path 122 is integrally formed in a housing portion 142 of the starting fuel supply device 124, and the suction path 122 connects with a suction path of an insulator (not shown). Furthermore, as shown in FIG. 9, the starting fuel supply paths 137 are formed as two paths extending in the up and down direction of FIG. 9. In addition, two starting fuel supply paths 137 are formed from the upper part of the housing portion 142 by drill machining, and a hole on the extension of the starting fuel supply path 137 to be formed in the process of machining is closed by a bolt 136.

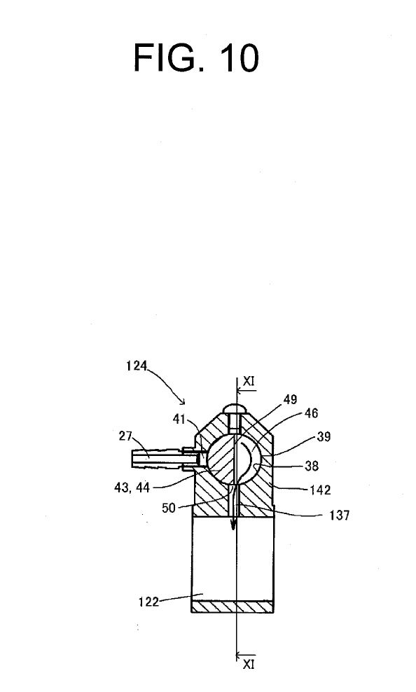

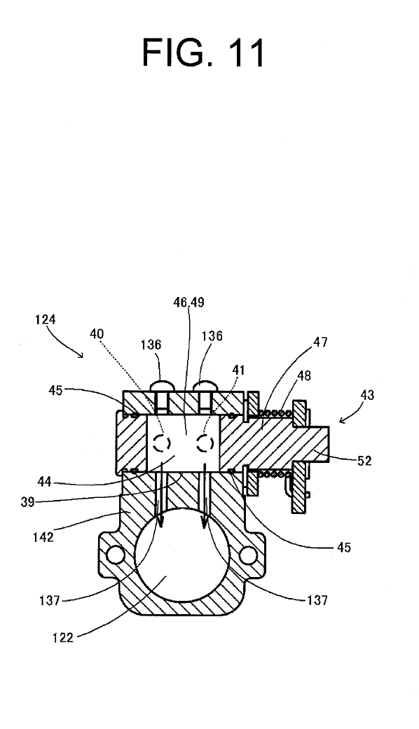

In the states shown in FIGS. 8 and 9, the torsion spring 48 biases the rotation portion 43, the semicircle portion 44 (the curved surface portion 50 and the flat portion 49 of the semicircle portion 44) partially closes the fuel inflow hole 40 and the fuel outflow hole 41, and the curved surface portion 50 of the semicircle portion 44 maintains the rotation portion 143 in a position (second rotation position) of facing the starting fuel supply path 137 to close the starting fuel supply path 137. For this reason, as shown in FIG. 8 by an arrow, fuel passes from the fuel inflow hole 40 to the starting fuel storage chamber 46, and flows to the second fuel path 27 via a one-way valve (not shown) 51 that allows fuel to flow from the fuel outflow hole 41 to the second fuel path 27. An extension shaft portion 53 is attached to the end portion 52 of the protrusion portion 47 of the rotation portion 43. The extension shaft portion 53 is extended from the rotation portion 43 toward the outside of the engine case 1002 (see FIG. 1) concentrically with the rotation portion 43 and is provided with the operation lever 2 at the end portion thereof protruded from the engine case 1002. When the operation lever 2 is rotated by 90 degrees such that the rotation portion 43 is rotated in a clockwise direction in FIG. 8 against the biasing force of the torsion spring 48, the curved surface portion 50 of the semicircle portion 44 is rotated in a direction of closing the fuel inflow hole 40 and the fuel outflow hole 41, and the rotation portion 43 enters the state shown in FIGS. 10 and 11. At this time, the rotation portion 43 is rotated to a position (the first rotation position) where the curved surface portion 50 of the semicircle portion 44 faces the fuel inflow hole 40 and the fuel outflow hole 41 to close the fuel inflow hole 40 and the fuel outflow hole 41, and the semicircle portion 44 (the curved surface portion 50 and the flat portion 49 of the semicircle portion 44) partially blocks the starting fuel supply path 137, whereby the starting fuel storage chamber 46 communicates with the starting fuel supply path 137. Moreover, as shown in the drawings by arrows, the fuel in the starting fuel storage chamber 46 flows in so as to be dropped in the suction path 122 via the starting fuel supply path 137.

According to such a starting fuel supply device 124, the same effect as the aforementioned starting fuel supply device 24 is obtained, and in addition, the rotation angle of the operation lever 2 (not shown) is reduced to 90°, and thus the operability can be further improved. Moreover, since the rotation direction of the rotation portion 43 at the time of operating the operation lever 2 is rotated in a direction in which the curved surface portion 50 of the semicircle portion 44 blocks the fuel inflow hole 40 and the fuel outflow hole 41, any one path of the starting fuel supply path 137, the fuel inflow hole 40, and the fuel outflow hole 41 is necessarily closed regardless of the position of the rotation portion 43, whereby it is possible to reliably prevent unnecessary fuel from being supplied from the starting fuel storage chamber 46 into the suction path 122. Thus, it is possible to perform the supply of a predetermined amount of fuel while maintaining high reliability when the engine 1 is started, which can further improve the starting performance of the engine 1.

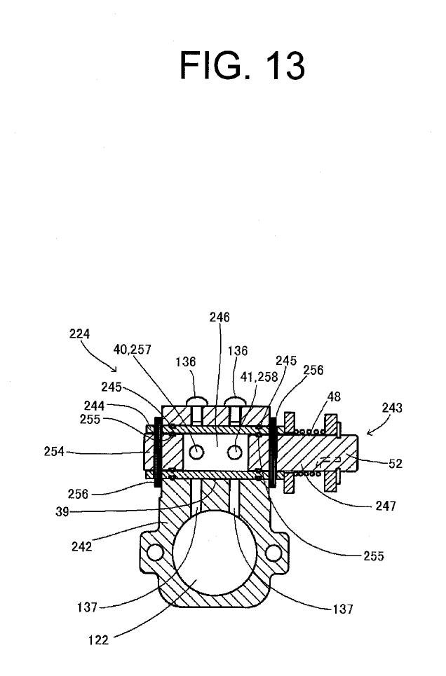

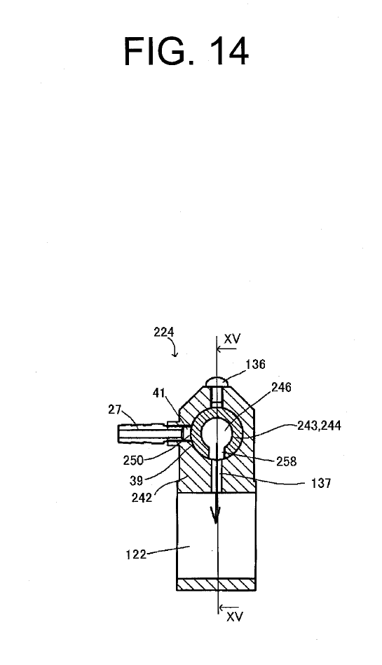

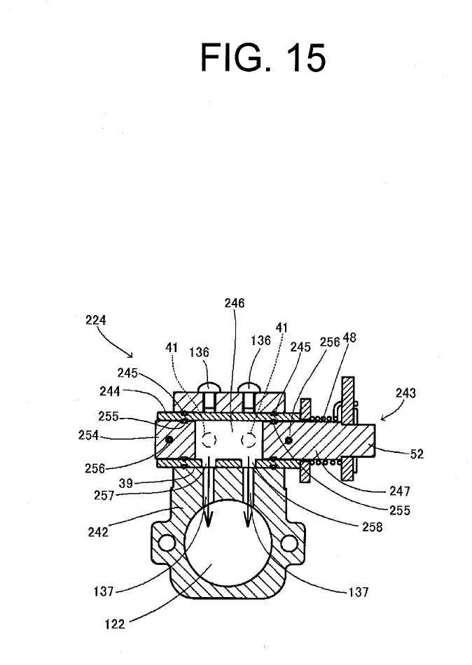

A starting fuel supply device 224 shown in FIGS. 12 to 16 is a device in which the rotation portion 43 of the aforementioned starting fuel supply device 124 is replaced by a rotation portion 243 partially having a hollow portion. As shown in FIGS. 12 and 13, the rotation portion 243 includes a cylinder portion 244 which has an outer diameter slightly smaller than a hole portion 39 of a housing portion 242 integrally formed with a suction path 122 and an approximately circular section with both ends opened, a protrusion portion 247 in which an end thereof is inserted into the cylinder portion 244 and the extension shaft portion 53 is attached to the other end thereof (the end portion 52), and a lid portion 254 which is inserted from the end portion of a side opposite to the side into which the protrusion portion 247 of the cylinder portion 244 is inserted. The protrusion portion 247 and the lid portion 254 are fixed to the cylinder portion 244 by pins 256, respectively. Furthermore, an O-ring 255 is provided between the protrusion portion 247, the lid portion 254 and the cylinder portion 244, and an O-ring 245 is provided between the cylinder portion 244 and the hole portion 39. Additionally, in the state in which the rotation portion 243 is assembled to the housing portion 242, the cylinder portion 244 is supported to the hole portion 39, the protrusion portion 247, and the lid portion 254 in an air-tight manner, that is, fuel does not leak from the portion between the cylinder portion 244, the hole portion 39, the protrusion portion 247, and the lid portion 245, and the cylinder portion 244 is rotatably supported to the hole portion 39. Furthermore, the cylinder portion 244 is provided with a first through-hole 257 and a second through-hole 258 which penetrate the periphery wall of the cylinder portion 244 in the radial direction. The first through-hole 257 and the second through-hole 258 are disposed so that the first through-hole 257 and the fuel inflow hole 40 overlap each other and the second through-hole 258 and the fuel outflow hole 41 overlap with each other in the state shown in FIGS. 12 and 13 and the first through-hole 257 and the second through-hole 258 overlap with the starting fuel supply path 137 in the state shown in FIGS. 14 and 15. Furthermore, the space of the inside of the cylinder portion 244 surrounded by the protrusion portion 247, the lid portion 254, and the inner periphery wall 38 of the hole portion 39 constitutes a starting fuel storage chamber 246 which stores a predetermined amount of fuel.

In the state shown in FIGS. 12 and 13, the torsion spring 48 biases the rotation portion 243, whereby the rotation portion 243 is maintained in a position (the second rotation position) where the first through-hole 257 and the second through-hole 258 of the cylinder portion 244 overlap with the fuel inflow hole 40 and the fuel outflow hole 41, respectively, and the curved surface portion 250 of the cylinder portion 244 faces the starting fuel supply path 137 to close the starting fuel supply path 137. For this reason, as shown in FIG. 12 by an arrow, fuel passes through the fuel inflow hole 40 to the starting fuel storage chamber 246 via the first through-hole 257, and flows to the second fuel path 27 via a one-way valve 51 (not shown) that allows fuel to flow from the second through-hole 258 to the fuel outflow hole 41 and the second fuel path 27. When the operation lever 2 (not shown) is rotated by 90 degrees to against the biasing force of the torsion spring 48 so that the rotation portion 243 is rotated from the state of FIG. 12 to the state of FIG. 14 in a counterclockwise direction, the rotation portion 243 is situated in a position (the first rotation position) where the curved surface portion 250 of the cylinder portion 244 blocks the fuel inflow hole 40 and the fuel outflow hole 41, and the first through-hole 257 and the second through-hole 258 overlap with the starting fuel supply path 137, respectively. Moreover, as shown in FIGS. 14 and 15 by arrows, the fuel in the starting fuel storage chamber 246 flows in so as to be dropped into the suction path 122 via the starting fuel supply path 137.

According to the starting fuel supply device 224 configured in this manner, the same effect as the aforementioned starting fuel supply devices 24 and 124 is obtained, and in addition, an inner space of the cylinder portion 244 is used as the starting fuel storage chamber 246. Thus, the storage space of fuel can be increased as compared to the aforementioned starting fuel supply devices 24 and 124. Thus, it is possible to reduce the diameter of the hole portion 39 of the housing portion 242 or the length of the center axial direction of the hole portion 39, the compactness of the starting fuel supply device 224 is possible, and it is possible to easily mount the starting fuel supply device 224 onto the engine 1. Furthermore, since fuel does not flow in the state in which the first through-hole 257 and the second through-hole 258 do not overlap with the fuel inflow hole 40 and the fuel outflow hole 41 or the starting fuel supply path 137, it is possible to make the position between the fuel inflow hole 40 and the fuel outflow hole 41 and the starting fuel supply path 137 approach a more circumferential direction from the aforementioned relationship and reduce the rotation angle of the rotation portion 243 from the aforementioned 90 degrees to a smaller angle, the rotation direction of the rotation portion 243 can be suitably selected in any rotation direction of the clockwise direction and the counterclockwise direction, whereby it is possible to further improve a degree of freedom and the operability in the disposition of the operation lever 2.

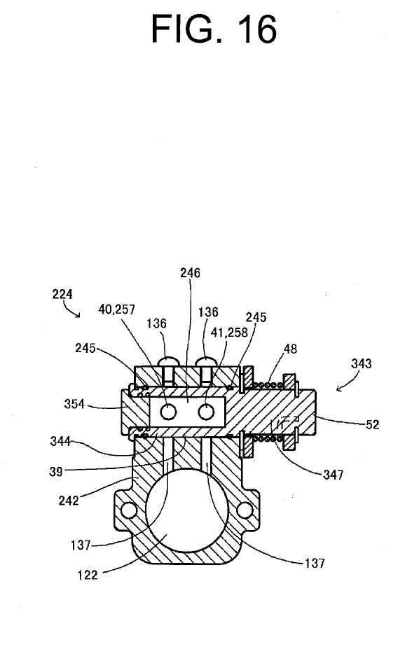

In addition, instead of the aforementioned rotation portion 243, as shown in FIG. 16, a rotation portion 343 may be used which has a configuration in which a cylinder portion 344 and a protrusion portion 347 are formed integrally and an open end of the cylinder portion 344 is blocked by a lid portion 354 made of an elastic body such as rubber. In this case, the same effect as the starting fuel supply device 224 using the aforementioned rotation portion 243 is obtained, and in addition, the number of the component is reduced as compared to the aforementioned rotation portion 243, and thus the manufacturing cost can be further reduced.

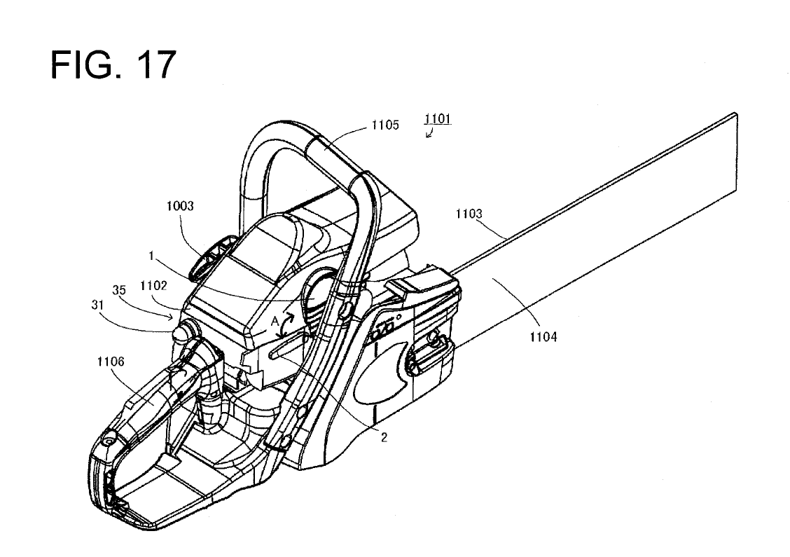

Furthermore, the engine 1 according to the aforementioned first exemplary embodiment is not limited to being mounted on the brush cutter 1001 but may be mounted on various engine operating machines, for example, as shown in FIG. 17, on the chainsaw 1101. In this case, the chainsaw 1101 includes an engine case 1102 with the engine 1 accommodated therein, a guide bar 1104 which is protruded from the engine case 1102 to guide a saw chain 1103, a front handle 1105 and a rear handle 1106 grasped by a worker, and a starter handle 1003 for starting the engine 1. The output of the engine 1 is controlled by a throttle lever (not shown) provided in the rear handle 1106 and is transmitted to the saw chain 1103 via a known driving mechanism. Furthermore, the fuel supply lever 2 for supplying the starting auxiliary fuel, and the operation portion 35 of the primary pump 31, which absorbs fuel from the fuel tank 29 to supply the carburetor 21 with fuel, are provided so as to be protruded from the engine case 1102.

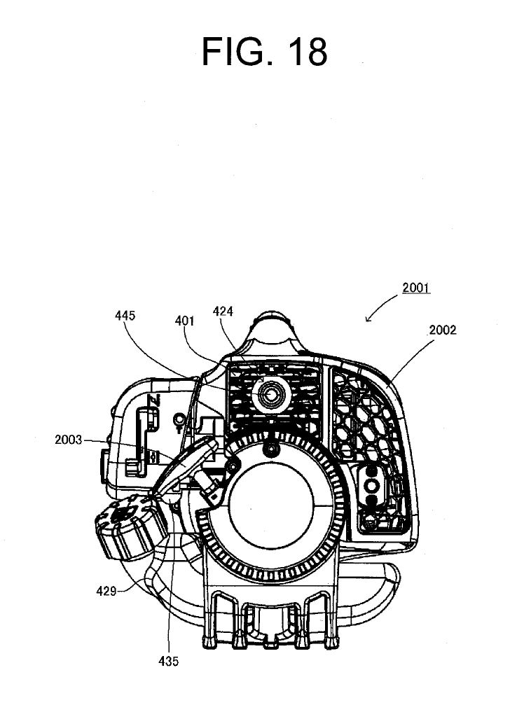

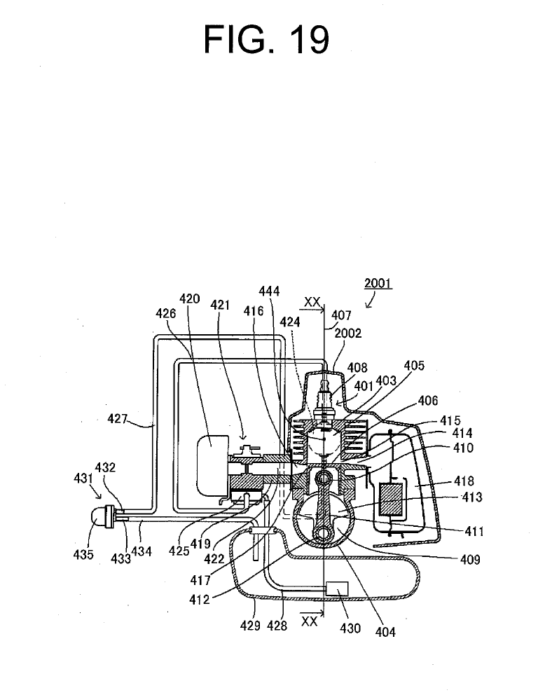

Next, a second exemplary embodiment of the invention will be described based on FIGS. 18 to 24 and 29. As shown in FIG. 29, a brush cutter 1001, on which a small two cycle engine 1 (hereinafter, referred to as an engine) suitable for being mounted onto a portable engine operating machine is mounted, is described. The brush cutter 1001 includes an engine case 1002 with the engine 1 (see FIGS. 18 and 19) accommodated therein, an operation rod 1011 protruded from the engine case 1002, to which a rotation knife 1010 is attached at a distal end thereof, and a starter handle 1003 for starting the engine 1. The output of the engine 1 is supplied to the rotation knife via a drive shaft inserted into the operation rod. A worker grasps a handle 1012 attached to the operation rod 1011 to operate the brush cutter 1001. Furthermore, an operation button 445 for operating the decompression device 424 provided in the engine 401 and supplying the starting auxiliary fuel, and an operation portion 435 of a primary pump, which sucks fuel from a fuel tank 29 to supply a carburetor (not shown) with fuel, are provided so as to be protruded from the engine case 2002.

As shown in FIG. 19, a crank case 404 is attached to a cylinder block 403 of the engine 401. In a cylinder bore 405 of the cylinder block 403, a piston 406 is moved up and down (up and down in FIG. 19) in an axis 407 direction of the cylinder bore 405. In FIG. 19, the piston 406 is situated in a bottom dead center. An ignition plug 408 is attached to a cylinder head inner wall surface of the cylinder head portion facing a top surface of the piston 406 above the cylinder bore 405. The cylinder bore 405 connects with a crank chamber 409 in the crank case 404 at a lower part thereof. The piston 406 connects with a crank shaft 412 which is rotatably supported to the crank case 404 via a piston pin 410 and a connecting rod 411. A crank weight 413 is attached to the crank shaft 412.

In an inner periphery wall of the cylinder bore 405, an exhaust opening 415 connecting with an exhaust port 414, a suction opening 417 connecting with a suction port 416, and a scavenging opening (not shown) connecting with a scavenging path (not shown), are opened. A muffler 418 connects with the cylinder block 403 so as to communicate with the exhaust port 414. Furthermore, an insulator 419 connects with the cylinder block 403 so as to communicate with the suction port 416, and a carburetor 421 linked to an air cleaner 420 connects with the insulator 419. Furthermore, a decompression device (starting fuel supply device) 424 shown in FIG. 19 by dotted lines is attached to the cylinder block 403. The decompression device 424 supplies a predetermined amount of fuel into the cylinder bore 405 and decompresses the pressure within the cylinder bore 405. A first fuel path (a fuel discharge path) 426, which discharges fuel overflowed from a first fuel storage portion 425 of the carburetor 421, and a second fuel path (a fuel return path) 427 are connected to an upper portion (an upper portion in FIG. 19) of the outer periphery wall of the decompression device 424. Furthermore, an end of a third fuel path (a fuel supply path) 428 connects with the fuel storage portion 425 of the carburetor 421, and the other end of the third fuel path 428 connects with a fuel suction port 430 within the fuel tank 429. Moreover, the second fuel path 427 connected to the starting fuel supply device 424 connects with a fuel absorption port 432 of a primary pump (notifying portion) 431. A fourth fuel path (a return path) 434 connected to the fuel tank 429 connects with a fuel discharge port 433 of the primary pump 431. In addition, the primary pump 431 is provided with an operation portion 435 that is elastically deformable and transmits light. The operation portion 35 absorbs fuel from the fuel absorption portion 432 into an inner portion thereof and discharges fuel absorbed in the inner portion thereof from the fuel discharge port 433 by repeating compression deformation and elastic restoration.

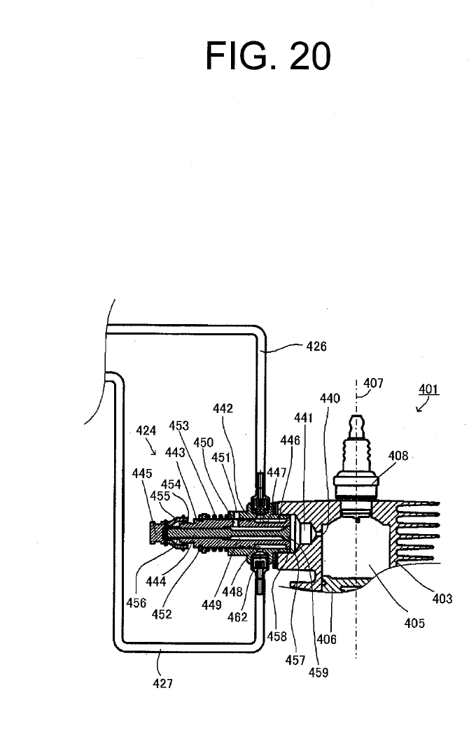

As shown in FIG. 20, a decompression opening 440 is formed at a top dead center side of the discharge opening 415 (see FIG. 19) of the cylinder bore 405. Further, a decompression path 441 extending from the decompression opening 440 perpendicularly to the axis 407 of the cylinder bore 405 is formed in the cylinder block 403. The decompression device 424 includes an outer casing portion 442 having an approximately cylindrical shape, which is inserted into and attached to the decompression path 441 of the cylinder block 403, an inner casing portion 443 having an approximately cylindrical shape that is supported to the inside of the outer casing portion 442 approximately concentrically with the outer casing portion 442 so as to be movable in the axial direction of the outer casing portion 442, a decompression valve 444 that is supported to the inside of the inner casing portion 443 approximately concentrically with the inner casing portion 443 so as to be moveable in the axial direction of the inner casing portion 443, and an operation button 445 that is attached to the decompression valve 444. Between the inside of the cylindrical side wall of the outer casing portion 442 and the outside of the cylindrical side wall of the inner casing portion 443, a starting fuel storage chamber 446 is formed which stores a predetermined amount of starting fuel therein. The amount of fuel stored in the starting fuel storage chamber 446 can be suitably changed by changing the inner shape of the starting fuel storage chamber 446, depending on the displacement, the used environment, or the like of the engine 401. The inner shape of the starting fuel storage chamber 446 can be changed by changing the size and the diameter in the axial direction of the outer casing portion 442, and the size and the diameter in the axial direction of the inner casing portion 443. In the cylindrical side wall of the outer casing portion 442, a fuel inflow hole 447 and a fuel outflow hole 448 are formed which communicate with the starting fuel storage chamber 446 at the inside thereof through the side wall. A first fuel path 426 connects with an outer end portion of the fuel inflow hole 447, and a second fuel path 427 connects with an outer end portion of the fuel outflow hole 448. Between the fuel outflow hole 448 and the second fuel path 427, there is provided a one-way valve 462 which allows fuel to flow from the fuel outflow hole 448 to the second fuel path 427. Furthermore, an air chamber 449 is formed between the inside of the cylindrical inner wall of the inner casing portion 443 and the outer periphery wall of the decompression valve 444. In a portion of the cylindrical side wall of the inner casing portion 443, which is at the operation button 445 side compared to the starting fuel storage chamber 446 and where the side wall of the inner casing portion 443 overlaps with the side wall of the outer casing portion 442, a first atmosphere opening 450 is formed which communicates with the air chamber 449 through the side wall. Furthermore, a second atmosphere opening 451 that communicates with the outside (atmosphere) through the side wall of the outer casing portion 442 is formed in the outer casing portion 442. The second atmosphere opening 451 is formed at a position overlapping with the first atmosphere opening 450 of the inner casing portion 443, in a state (state of FIG. 20) where the inner casing portion 443 is separated farthest from the cylinder bore 450. In the state in which the first atmosphere opening 450 and the second atmosphere opening 451 overlap with each other, the air chamber 449 communicates with the atmosphere via the first atmosphere opening 450 and the second atmosphere opening 451 to constitute the decompression path, and the first atmosphere opening 450 and the second atmosphere opening 451 constitute an atmosphere opening.

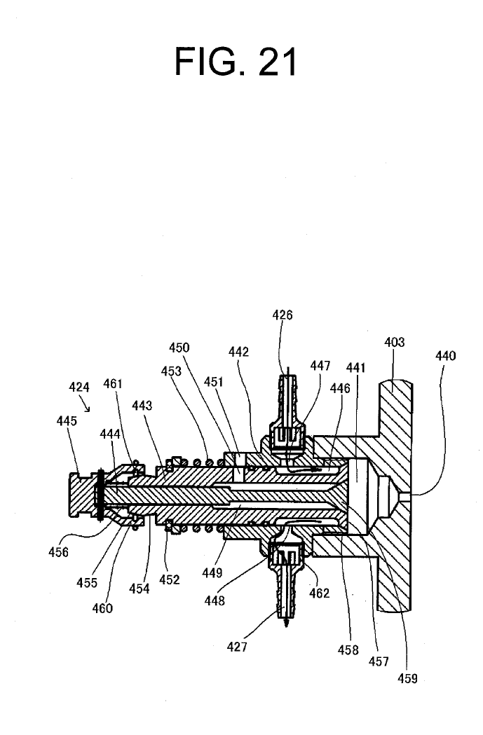

As shown in FIG. 21, between the end portion of the side separated from the cylinder bore 405 of the outer casing portion 442 and a stopper 452 protruding from the cylindrical side wall of the inner casing portion 443 to the outside, there is provided a first coil spring 453 which is wound along the cylindrical side wall of the inner casing portion 443 to bias the inner casing portion 443 in a direction so as to be separated from the cylinder bore 405. In addition, a drum-shaped protrusion portion 454, in which a central portion thereof has a diameter wider than those of both end portions thereof, is formed in the end portion of the side of the inner casing portion 443 separated from the cylinder bore 405. Between the end portion 455 of the protrusion portion 454 and the operation button 445 attached to the decompression valve 444, a second coil spring 456 is provided which is wound along the cylindrical side wall of the decompression valve 444 to bias the decompression valve 444 in a direction so as to be separated from the cylinder bore 405. In the end portion (the end portion of the decompression path 441 side) of the side of the inner casing portion 443 facing the decompression opening 440, an enlarged diameter portion 457 is formed in which an outer diameter of the cylindrical side wall is enlarged so as to exceed the inner diameter of the outer casing portion 442. As shown in FIGS. 20 and 21, in the state in which the inner casing portion 443 is separated farthest from the cylinder bore 405 due to the biasing force of the first coil spring 453, the enlarged diameter portion 457 comes into contact with the first end portion 458 of the decompression path 441 of the outer casing portion 442, whereby the starting fuel storage chamber 446 and the decompression path 441 are disconnected. Furthermore, in the end portion (the end portion of the decompression path 441 side) of the side of the decompression valve 444 facing the decompression opening 440, a conical opening and closing portion 459 is formed in which, as it goes toward the decompression opening 440, the diameter thereof is enlarged and becomes an outer diameter larger than the inner diameter of the enlarged diameter portion 457 in the endmost portion thereof. As shown in FIGS. 20 and 21, in the state in which the decompression valve 444 is separated farthest from the cylinder bore 405 due to the biasing force of the second coil spring 456, the opening and closing portion 459 comes into contact with the enlarged diameter portion 457 (the end portion inside the enlarged diameter portion 457) of the inner casing portion 443, and the air chamber 449 and the decompression path 441 are disconnected. Furthermore, a washer 461 extending toward the protrusion portion 454 of the inner casing portion 443 is provided inside an extension portion 460 that is extended from the operation button 445 to the cylinder bore 405 side. The washer 461 comes into contact with the outer side surface of the protrusion portion 454, and when a force equal to or greater than a predetermined magnitude is generated in the axial direction of the decompression valve 444, the washer 461 exceeds the maximum enlarged diameter portion of the drum-shaped outside surface of the protrusion portion 454 and allows the movement in the axial direction. However, when the axial force is smaller than a predetermined magnitude, the washer 461 does not exceed the maximum enlarged diameter portion of the protrusion portion 454, and the washer 461 restricts the movement of the decompression valve 444 in the axial direction. In order that the washer 461 exceeds the maximum enlarged diameter portion of the protrusion proton 454, there is a need for a force that is greater than the biasing force of the second coil spring 456.

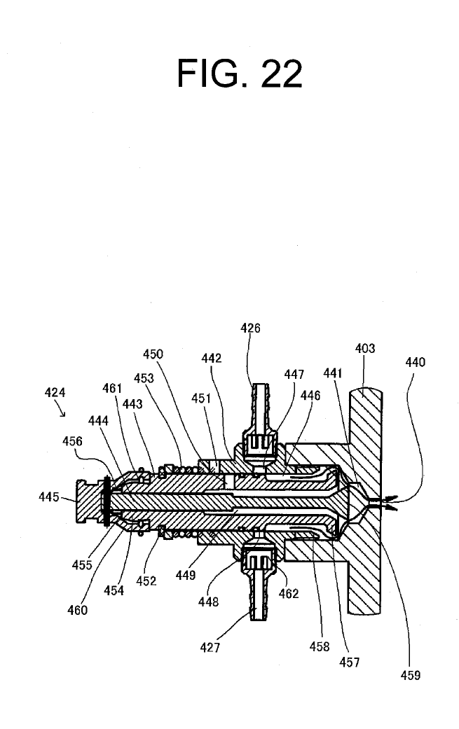

When the operation button 445 is pressed in the direction of the cylinder bore 405 against the biasing force of the first coil spring 453 and the biasing force of the second coil spring 456, respectively, and so that the washer 461 exceeds the maximum enlarged diameter portion of the protrusion portion 454, the decompression valve 444 is moved to the cylinder bore 405 side and the washer 461 exceeds the maximum enlarged diameter portion of the protrusion portion 454. The end portion of the extension portion 460 of the operation button 445 facing the cylinder bore 405 comes into contact with the inner casing portion 443, and the decompression valve 444 and the inner casing portion 443 are moved to the cylinder bore 405 side until the second coil spring 456 enters the most contracted state. In this state, that is, as shown in FIG. 22, in the state in which the decompression valve 444 and the inner casing portion 443 are moved farthest to the cylinder bore 405 side, the second atmosphere opening 451, the fuel inflow hole 447, and the fuel outflow hole 448 of the outer casing portion 442 are closed by the cylindrical side wall of the inner casing portion 443, respectively. Furthermore, the first atmosphere opening 450 of the inner casing portion 443 is closed by the side wall of the inside of the outer casing portion 442. Moreover, the enlarged diameter portion 457 of the inner casing portion 443 is moved from the end portion 458 of the decompression path 441 side of the outer casing portion 442 to the decompression opening 440 side, so that the starting fuel storage chamber 446 communicates with the decompression path 441, and the opening and closing portion 459 of the decompression valve 444 is moved from the end portion 458 of the decompression path 441 side of the enlarged diameter portion 457 of the inner casing portion 443 to the decompression opening 440 side, whereby the air chamber 449 communicates with the decompression path 441. As shown in FIG. 22 by the arrow, the fuel in the starting fuel storage chamber 446 flows from the decompression path 441 into the cylinder bore 405 through the decompression opening 440. In addition, the operation button 445 and the inner casing portion 443 constitute fuel delivery portion that delivers the fuel in the starting fuel storage chamber 446 into the cylinder bore 405, and the decompression path 441 and the decompression opening 440 constitute a starting fuel supply path.

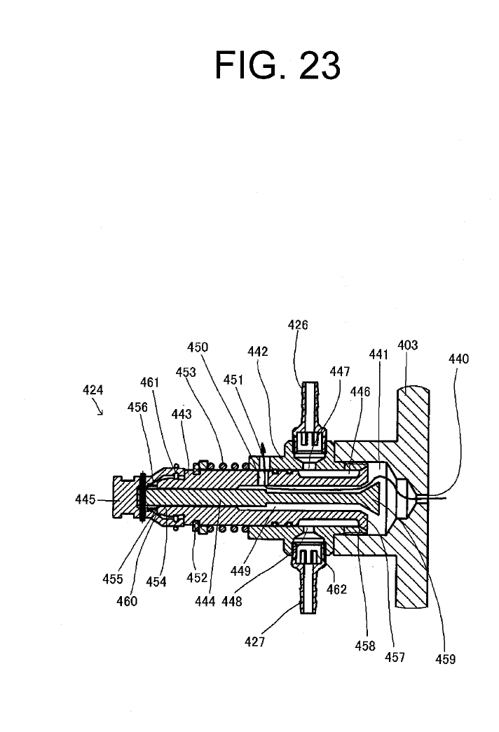

When releasing the operation button 445 from the state shown in FIG. 22, as shown in FIG. 23, the end portion of the extension portion 460 of the operation button 445 facing the cylinder bore 405 side comes into contact with the inner casing portion 443, and in the state in which the decompression valve 444 is moved to the cylinder bore 405 side, the inner casing portion 443 is moved in a direction of being separated from the cylinder bore 405 due to the biasing force of the first coil spring 453. In this state, the second atmosphere opening 451 of the outer casing portion 442 overlaps with the first atmosphere opening 450 of the inner casing portion 443, and the fuel inflow hole 447 and the fuel outflow hole 448 communicate with the starting fuel storage chamber 446, respectively. Furthermore, the enlarged diameter portion 457 of the inner casing portion 443 comes into contact with the end portion 458 of the decompression path 441 side of the outer casing portion 442, thereby shutting off the communication of the starting fuel storage chamber 446 with the decompression path 441. However, the opening and closing portion 459 of the decompression valve 444 is moved from the end portion 458 of the decompression path 441 side of the enlarged diameter portion 457 of the inner casing portion 443 to the decompression opening 440 side, whereby the air chamber 449 is kept in the state of communicating with the decompression path 441. Moreover, the cylinder bore 405 communicates with the outside (atmosphere) through the decompression opening 440, the decompression path 441, the air chamber 449, the first atmosphere opening 450, and the second atmosphere opening 451. In addition, when the pressure within the cylinder bore 405 rises, as shown in FIG. 23 by the arrow, air in the cylinder bore 405 is discharged from the second atmosphere opening 451 to the outside, thereby avoiding a rise in pressure within the cylinder bore 405. Furthermore, when the pressure within the cylinder bore 405 rises to exceed a predetermined pressure, the decompression valve 444 is moved to the left side so that the opening and closing portion 459 of the decompression valve 444 receives force in a direction (left direction of the drawings) of being separated from the decompression opening 440 and the washer 461 exceeds the maximum enlarged diameter portion of the protrusion portion 454. By the movement of the decompression valve 444, the communication of the air chamber 449 with the decompression path 441 is automatically shut off.

According to the engine 401 configured in this manner, when a worker starts the engine 401, firstly, an operation of pressing the operation portion 435 of the primary pump 431 is performed, thereby absorbing fuel from the fuel tank 429. The fuel absorbed from the fuel suction port 430 of the fuel tank 429 flows into the fuel storage portion 425 of the carburetor 421 through the third fuel path 428. Moreover, the fuel overflowed from the fuel storage portion 425 flows from the fuel inflow hole 447 of the decompression device 424 into the starting fuel storage chamber 446 through the first fuel path 426. Additionally, the fuel overflowed from the starting fuel storage chamber 446 passes from the fuel outflow hole 448 to the one-way valve 462 and the second fuel path 427 and flows from the fuel suction port 432 of the primary pump 431 into the operation portion 435. Moreover, the flow overflowed from the operation portion 435 returns from the fuel discharge port 433 to the fuel tank 429 through the fourth fuel path 434. A worker operates the primary pump 431 until it is confirmed that fuel flows into the operation portion 435. Moreover, after confirming that fuel reached the operation portion 435 of the primary pump 431, the worker presses the operation button 445 of the decompression device 424 until the operation button 445 does not move. By the operation, the starting fuel storage chamber 446 of the decompression device 424 and the decompression path 441 communicate with each other, whereby a predetermined amount of fuel within the starting fuel storage chamber 446 flows into the cylinder bore 405 through the decompression path 441. Moreover, when a worker releases the operation button 445, the inner casing portion 443 is automatically moved in a direction of being separated from the cylinder bore 405 by the biasing force of the first coil spring 453. Meanwhile, the decompression valve 444 is kept in the state of being moved to the cylinder bore 405 side with respect to the inner casing portion 443, that is, the opening and closing portion 459 of the decompression valve 444 is maintained in the state of being moved to the decompression opening 440 side from the end portion 458 of the decompression path 441 side of the enlarged-diameter portion, whereby the air chamber 449 and the decompression path 441 are kept in the communication state. Moreover, the cylinder bore 405 communicates with the outside (atmosphere) through the decompression opening 440, the decompression path 441, the air chamber 449, the first atmosphere opening 450, and the second atmosphere opening 451. When a worker pulls the starter handle 2003 (see FIG. 18) to start the engine 401, the fuel flowed from the decompression opening 440 exists in the cylinder bore 405. For this reason, it is possible to provide the mixed air having a high fuel concentration into the cylinder bore 5, and the engine 401 can be easily started. Meanwhile, since the cylinder bore 405 communicates with the outside (atmosphere), a force of pulling the starter handle 2005 is reduced. Thus, the engine 401 can be started easily.

In this manner, since the decompression device 424 integrally includes a function of performing the decompression and a function of performing the starting fuel supply, it is possible to use a decompression hole provided in the cylinder block 403, whereby the machining of the cylinder block 403 side can be suppressed to a minimum to suppress the cost. Furthermore, since two functions of performing the decompression and supplying the starting fuel supply can be realized only by the decompression operation at the time of the starting, the operation amount to be performed at the time of starting the engine 401 is reduced, which can drastically improve the operability upon starting the engine 401. Furthermore, since the starting fuel is directly supplied into the cylinder bore 405 by the decompression device 424, as compared to a configuration in which the starting fuel is supplied into the suction path of the carburetor, the amount of fuel to be supplied can be reduced, and thus it is possible to suppress an increase in size of the decompression device 424. Furthermore, since the decompression device 424 is provided to the upstream of the primary pump 431 having the operation portion 435, it is possible to easily ascertain that a predetermined amount of fuel exists in the starting fuel storage chamber 446 of the decompression device 424 by recognizing that fuel reaches the operation portion 435. Thus, after recognizing that fuel reaches the operation portion 435, it is possible to reliably transport a predetermined amount of fuel from the starting fuel storage chamber 446 into the cylinder bore 405 by operating the operation button 445. As a result, it is possible to more easily perform the starting operation of the engine 401 that uses the decompression device 424. Furthermore, in the state of pressing the operation button 445, the fuel inflow hole 447 and the fuel outflow hole 448 are shut off by the inner casing portion 443. Thus, unnecessary fuel is not supplied into the cylinder bore 405 and the mixed air of a suitably high fuel concentration can be supplied into the cylinder bore 405, which suppresses an occurrence of a problem that the ignition plug 408 is covered, whereby the starting of the engine 401 can be easily performed. Furthermore, in the state in which the starting fuel storage chamber 446 communicates with the decompression path 441, the first atmosphere opening 450 and the second atmosphere opening 451 are closed, and in the state in which the first atmosphere opening 450 and the second atmosphere opening 451 communicate with the atmosphere, the starting fuel storage chamber 446 and the decompression path 441 are closed, which makes it possible to prevent the starting fuel from flowing from the second atmosphere opening 451 to the outside.

In addition, if the position where the decompression opening 440 is formed is a position where the pressure rises within the cylinder bore 405 when the piston of the top dead center side rises higher than the discharge opening 415, the position is not limited to the aforementioned position. Furthermore, the attachment position of the decompression device 424 is also not limited to the side portion of the cylinder block 403. For example, the decompression opening 440 may be formed on the cylinder head inner wall surface of the cylinder head portion that faces the top surface of the piston 406 of the cylinder block 403, and the decompression device 424 may be attached to the cylinder head portion. In this case, in the state of placing the brush cutter 2001 on the ground, the decompression device 424 is positioned above the cylinder bore 405. Thus, in addition to the aforementioned effect, it is possible to more reliably supply a predetermined amount of fuel into the cylinder bore 405 using gravity, and the starting performance of the engine 401 can be further improved.

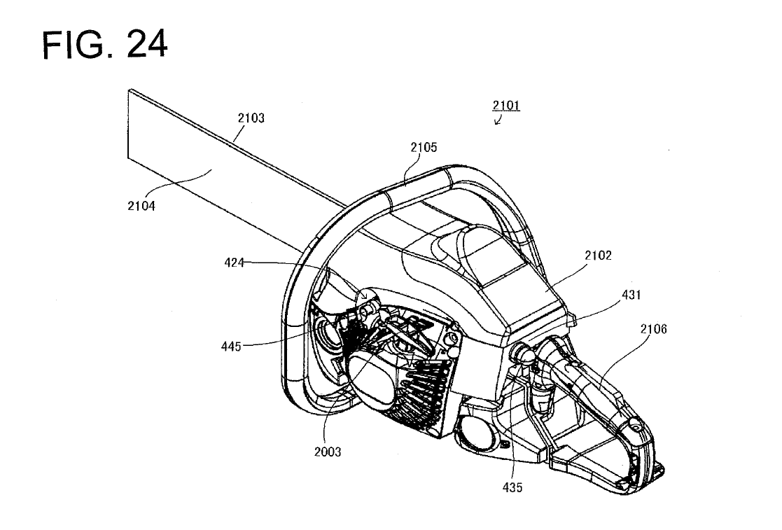

Furthermore, the engine 401 according to the aforementioned second exemplary embodiment may be mounted on various engine operating machines, for example, as shown in FIG. 24, on the chainsaw 2101, without being limited to be mounted on the brush cutter 2001. In this case, the chainsaw 2101 includes an engine case 2102 with the engine 401 accommodated therein, a guide bar 2104 that is protruded from the engine case 2102 to guide the saw chain 2103, a front handle 2105 and a rear handle 2106 grasped by a worker, and a starter handle 2003 for starting the engine 401. The output of the engine 401 is controlled by a throttle lever (not shown) provided in the rear handle 2206 and is transmitted to the saw chain 2103 via a known driving mechanism. Furthermore, an operation button 445 for operating the decompression device 424 provided in the engine 401 and supplying the starting auxiliary fuel, and an operation portion 435 of a primary pump 431, which absorbs fuel from the fuel tank 429 to supply the carburetor 421 with fuel, are provided so as to protrude from the engine case 2102.

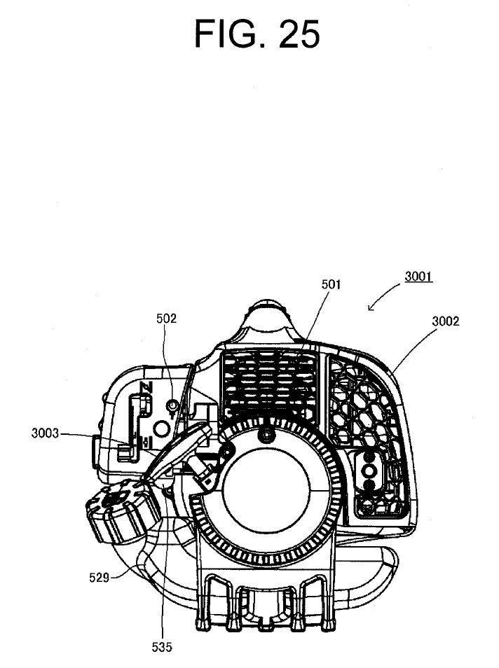

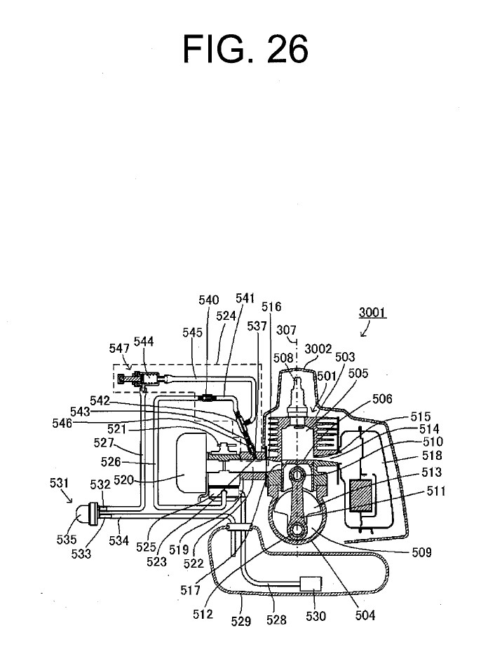

Next, a third exemplary embodiment of the invention will be described based on the FIGS. 25 to 29. As shown in FIG. 29, a brush cutter 1001, on which a small two cycle engine 1 (hereinafter, referred to as an engine) suitable for being mounted onto a portable engine operating machine is mounted, is described. The brush cutter 1001 includes the engine case 1002 with the engine 1 (see FIGS. 25 and 26) accommodated therein, the operation rod 1011 protruding from the engine case 1002, to which the rotation knife 1010 is attached at a distal end thereof, and a starter handle 1003 for starting the engine 1. The output of the engine 1 is supplied to the rotation knife via a drive shaft inserted into the operation rod. A worker grasps the handle 1012 attached to the operation rod 1011 to operate the brush cutter 1001. Furthermore, a fuel supply button 554 for supplying the starting auxiliary fuel, and an operation portion 535 of a primary pump, which sucks fuel from the fuel tank 529 to supply a carburetor (not shown) with fuel, are provided so as to be protruded from the engine case 3002.

As shown in FIG. 26, a crank case 504 is attached to a cylinder block 503 of the engine 501. In a cylinder bore 505 of the cylinder block 503, a piston 506 is moved up and down (up and down in FIG. 26) in an axial 507 direction of the cylinder bore 505. In FIG. 26, the piston 506 is situated in a bottom dead center. An ignition plug 508 is attached to a top portion above the cylinder bore 505. The cylinder bore 505 connects with a crank chamber 509 in the crank case 504 at a lower part thereof. The piston 506 connects with a crank shaft 512 which is rotatably supported by the crank case 504 via a piston pin 510 and a connecting rod 511. A crank weight 513 is attached to the crank shaft 512.

In an inner periphery wall of the cylinder bore 505, an exhaust opening 515 connecting with an exhaust port 514, a suction opening 517 connecting with a suction port 516, and a scavenging opening (not shown) connecting with a scavenging path (not shown) are opened. A muffler 518 connects with the cylinder block 503 so as to communicate with the exhaust port 514. Furthermore, a insulator 518 connects with the cylinder block 503 so as to communicate with the suction port 516, and a carburetor 521 linked to an air cleaner 520 connects with the insulator 519. Moreover, a through-hole 523 is formed in the upper part of the axial 527 direction of the suction path 522 of the insulator 519, that is, in a position that becomes an upper part of the suction path 522 in the state of placing the brush cutter 3001 on the ground. Moreover, a starting fuel supply path 537 of a starting fuel supply device 524 described later connects with the through-hole 523. A first fuel path (a fuel discharge path) 526 which discharges the fuel overflowed from the fuel storage portion 525 of the carburetor 521, and a second fuel path (a fuel return path) 527 are connected to the starting fuel supply device 524. Furthermore, an end of a third fuel path (a fuel supply path) 528 connects with the fuel storage portion 525 of the carburetor 521, and the other end of the third fuel path 528 connects with a fuel suction port 530 in the fuel tank 529. Moreover, the second fuel path (a fuel return path) 527 connected to the starting fuel supply device 524 connects with a fuel absorption port 532 of a primary pump (notifying portion) 531. A fourth fuel path (a return path) 534 connected to the fuel tank 529 connects with a fuel discharge port 533 of the primary pump 531. In addition, the primary pump 531 is provided with an elastically deformable operation portion 535 which absorbs fuel from the fuel absorption portion 532 in the inner portion and discharges the fuel absorbed in the inner portion from the fuel discharge port 533 by repeating a compression deformation and an elastic restoration.

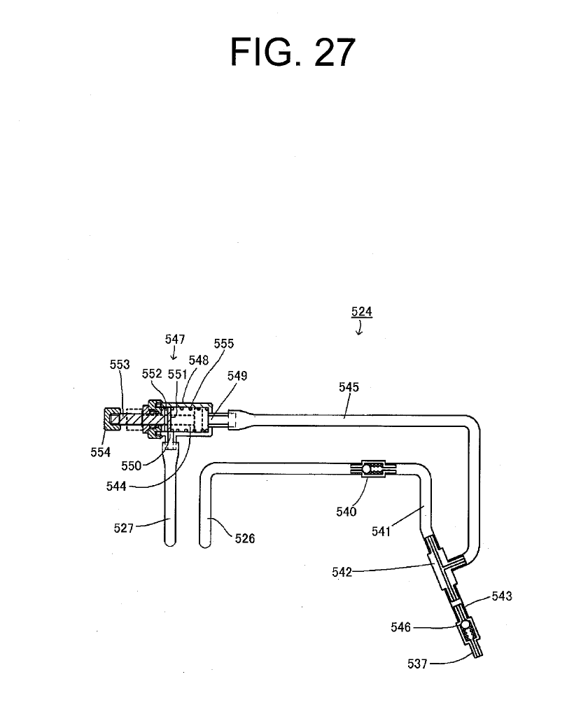

As shown in FIG. 27, the starting fuel supply device 524 includes a first one-way valve 540 that connects with the first fuel path 526 to allow fuel to flow from the carburetor 521 toward the starting fuel supply device 524, and a connection path 541 that connects with the downstream of the first one-way valve 540. A division portion 542 connects with the downstream of the connection path 541, and the division portion 542 is divided into a starting fuel inflow path 543 that causes the first connection path 541 to face the starting fuel supply path 537, and a storage portion inflow path 545 described later that causes a predetermined amount of fuel to face the starting fuel storage portion (a starting fuel storage chamber) 544. Between the starting fuel inflow path 543 and the starting fuel supply path 537, there is provided a second one-way valve 546 which allows fuel to flow from the starting fuel inflow path 543 to the starting fuel supply path 537, when a pressure difference between the starting fuel inflow path 543 and the starting fuel supply path 537 is equal to or greater than a predetermined value, for example, in the case of the pressure that is greater than a pressure difference generated by a suction negative pressure of the engine 501. The storage portion inflow path 545 connects with a storage portion inflow opening 549 that is formed in the closed end portion of the cylinder 548 having an approximately cylindrical shape and an opened one end of a fuel delivery device (fuel delivery portion) 547. Furthermore, a fuel return opening 550 penetrating the side wall is formed in the cylindrical side wall of the cylinder 548. The inner portion of the cylinder 548 is provided with a slide 551 which can slide in the inner periphery wall of the cylinder 548 in the axial direction of the cylinder 548. In addition, an O-ring 552 is provided on the outer periphery surface of the piston 551 to maintain the portion between the outer periphery surface of the piston 551 and the inner periphery surface of the cylinder 548 in an airtight manner. Furthermore, the piston 551 is provided with a shaft 553 that is extended toward the outside (left direction of the drawing) of the cylinder 548, and the shaft 553 is provided with a piston operation portion 554 that is operated by a worker. Furthermore, a coil spring 555 is provided between the piston 551 and the end portion of the closed side of the cylinder 548, thereby biasing the piston 551 toward a direction (a left direction of the drawings) of being separated from the end portion of the closed side of the cylinder 548.

As shown in FIG. 27 by solid lines, in the state in which the piston 551 is situated in the left end in the cylinder 548 (the state in which the piston 551 is in a first sliding position), a starting fuel storage portion 544 is formed in which a predetermined amount of fuel is stored between the inner wall of the cylinder 548 and the piston 551, and the storage portion inflow opening 549 and the fuel return path opening 550 communicate with the starting fuel storage portion 544, respectively. Thus, the fuel, which flows from the first fuel path 526 into the storage portion inflow opening 549 via the first one-way valve 540, the division portion 542, and the storage portion inflow path 545, flows from the fuel return path opening 550 into the second fuel path 527 via the starting fuel storage portion 544. In addition, a configuration may be added in which a sponge is provided in the starting fuel storage portion 544 between the inner wall of the cylinder 548 and the piston 551, where the sponge is impregnated with fuel and maintained. Meanwhile, as shown in FIG. 27 by dotted lines, in the state (state in which the piston 551 is in the second sliding position) in which a worker presses the piston operation portion 554 of the piston 551 against the biasing force of the coil spring 555 and the piston 551 is in the farthest moved position in the inner portion of the cylinder 548, the communication of the fuel return path opening 550 and the storage portion inflow opening 549 with the starting fuel storage portion 544 is shut off. Furthermore, the fuel in the starting fuel storage portion 544 flows into the storage portion inflow path 545, the pressure in the storage portion inflow path 545, the division portion 543, the connection path 541, and the starting fuel inflow path 543 rises, whereby the second one-way valve 546 is opened. Moreover, a predetermined amount of fuel is supplied from the opened second one-way valve 546 into the suction path 522 via the starting fuel supply path 537. In addition, when a worker releases his hands from the piston operation portion 554, the piston automatically returns to the first sliding position by the biasing force of the coil spring 555.

According to the cylinder bore 501 configured in this manner, when a worker starts the engine 501, firstly, an operation of pressing the operation portion 535 of the primary pump 531 is performed to absorb fuel from the fuel tank 529. The fuel absorbed from the fuel suction port 530 of the fuel tank 529 flows into the fuel storage portion 525 of the carburetor 521 through the third fuel path 528. Moreover, fuel overflowed from the fuel storage portion 525 passes from the first fuel path 526 to the first one-way valve 540, the connection path 541, the division portion 542, and the storage portion inflow path 545 of the starting fuel supply device 524, and flows from the storage portion inflow opening 549 into the starting fuel storage portion 546 of the fuel delivery device 547. Moreover, the flow overflowed from the starting fuel storage portion 546 passes from the fuel return opening 550 into the second fuel path 527, and flows from the fuel absorption port 532 of the primary pump 531 into the operation portion 535. Moreover, the flow overflowed from the operation portion 535 returns from the fuel discharge port 533 through the fourth fuel path 534 to the fuel tank 529. In addition, a worker operates the primary pump 531 until confirming that fuel flows into the operation portion 535. Moreover, after confirming that fuel reaches up to the operation portion 535 of the primary pump 531, the worker presses the piston operation piston 554 of the piston 551 against the biasing force of the coil spring 555, thereby moving the piston 551 to the second sliding position. By the operation, the fuel in the starting fuel storage portion 544 flows into the storage portion inflow path 545, the pressure within the storage portion inflow path 545, the division portion 542, the connection path 541, and the starting fuel inflow path 543 rises, whereby the second one-way valve 546 is opened. Moreover, a predetermined amount of fuel flows from the opened second two-way valve 546 into the suction path 522 via the starting fuel supply path 537. When a worker releases his hand from the piston operation portion 554, the portion automatically returns to the first sliding position by the biasing force of the coil spring 555. Additionally, when a worker pulls the starter handle 3003 (see FIG. 25) to start the engine 501, fuel supplied from the starting fuel supply path 537 exists in the suction path 522. For this reason, a mixed air having a high fuel concentration can be supplied into the cylinder bore 505, and the engine 501 is easily started. Thus, it is possible to reduce the number of operation of the starter handle 3007 to easily perform the starting of the engine 501.

In this manner, since the starting fuel supply device 524 is provided to the upstream of the primary pump 531 having the operation portion 535, it is possible to easily ascertain that a predetermined amount of fuel exists in the starting fuel storage chamber 546 of the starting fuel supply device 524 by recognizing that fuel reaches the operation portion 535. Thus, after recognizing that fuel reaches the operation portion 535, it is possible to reliably transport a predetermined amount of fuel into the suction path 522 by pressing the piston operation portion 554. As a result, it is possible to more easily perform the starting operation of the engine 501 that uses the starting fuel supply device 524. Thus, when the communication of the fuel return path opening 550 and the storage portion inflow opening 549 with the starting fuel storage portion 544 is shut off by pressing the piston operation portion 554, if the state is not become in which the pressure in the storage portion inflow path 545, the division portion 542, the connection path 541, and the starting fuel inflow path 543 rises, and the second one-way valve 546 is opened, a predetermined amount of fuel is not supplied from the starting fuel supply path 537 to the suction path 522. Thus, unnecessary fuel is not supplied from the starting fuel supply path 537 to the suction path 522, the mixed air of a suitably high fuel concentration can be supplied into the cylinder bore 505, which suppresses an occurrence of problem that the ignition plug 508 is covered, whereby the starting of the engine 501 can be easily performed. Furthermore, by releasing the piston operation portion 554, the piston operation portion 554 and the piston 551 automatically return to the original position (the state in which the piston 551 is in the first sliding position). For this reason, the starting fuel supply device 524 is more easily operated when the engine 501 is started, whereby it is possible to remarkably improve the operability at the time of the starting.

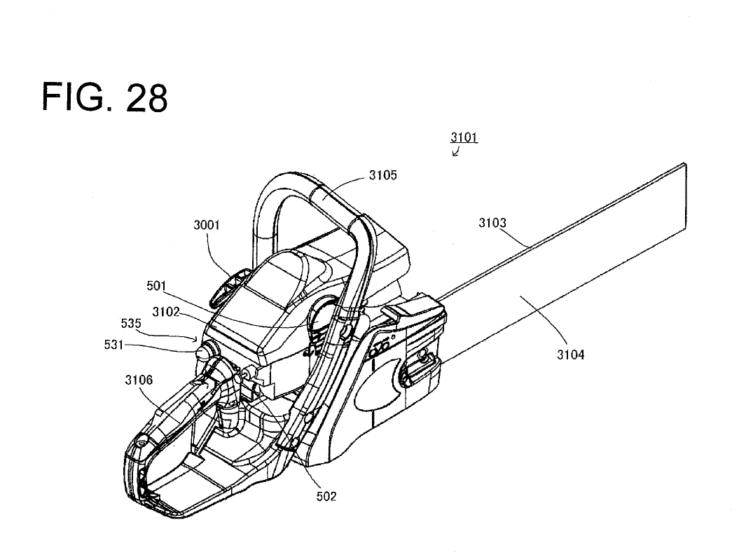

Furthermore, the engine 500 according to the aforementioned third exemplary embodiment may be mounted on various types of engine operating machines, for example, as shown in FIG. 28, on the chainsaw 3101 without being limited to be mounted on the brush cutter 3001. In this case, the chainsaw 3101 includes an engine case 3102 with the engine 501 accommodated therein, a guide bar 3104 that is protruded from the engine case 3102 to guide the saw chain 3103, a front handle 3105 and a rear handle 3106 grasped by a worker, and a starter handle 3003 for starting the engine 501. The output of the engine 501 is controlled by a throttle lever (not shown) provided in the rear handle 3106 and is transmitted to the saw chain 3103 via a known driving mechanism. Furthermore, the fuel supply button 502 for supplying the starting auxiliary fuel, and the operation portion 535 of the primary pump 531, which absorbs fuel from the fuel tank 529 to supply the carburetor 521 with fuel, are provided so as to be protruded from the engine case 3102.

In addition, the aforementioned engines 1, 401, and 501 may be four cycle engines without being limited to the two cycle engine. Furthermore, the engines 1, 401, and 501 may be mounted on the engine operating machine such as a blower, a hedge trimmer, and a generator besides the cutters 1001, 2001, and 3001 and the chainsaws 1101, 2101, and 3101.

The present invention provides illustrative, non-limiting aspects as follows:

(1) According to a first aspect, there is provided an engine including: a cylinder block formed with a cylinder bore; a carburetor including, a fuel storage portion that stores fuel supplied from a fuel tank via a fuel supply path and supplies the fuel to a suction path, and a fuel discharge path that discharges fuel overflowed from the fuel storage portion; a starting fuel supply device including, a starting fuel storage chamber that is provided on a fuel route defined by the fuel tank and the carburetor and stores a predetermined amount of fuel, a fuel delivery portion that delivers the fuel in the starting fuel storage chamber to a starting fuel supply path connected to the suction path or the cylinder bore, and a fuel return path that discharges the fuel overflowed from the starting fuel storage chamber; and a notifying portion that visually notifies that the starting fuel storage chamber is filled with fuel.

(2) According to a second aspect, there is provided the engine according to the first aspect, wherein the notifying portion is a primary pump including, a fuel absorption port to which fuel is supplied via the fuel return path, a fuel discharge port that connects with a return path of the fuel tank, and an operation portion that is elastically deformable and transmits light, the operation portion absorbing fuel from the fuel absorption port to an inner portion thereof and discharging the absorbed fuel to the fuel discharge port by repeating compression deformation and elastic restoration.

(3) According to a third aspect, there is provided the engine according to the first or second aspects, wherein the notifying portion is provided so as to protrude from an engine case that covers at least a part of the cylinder block or the carburetor.

(4) According to a fourth aspect, there is provided the engine according to any one of the first to third aspect, wherein fuel is supplied to the starting fuel supply device via the fuel discharge path.

(5) According to a fifth aspect, there is provided the engine according to any one of the first to fourth aspects, wherein, when the fuel delivery portion for delivering the fuel to the starting fuel supply path is operated, the starting fuel supply device causes the starting fuel supply path and the starting fuel storage chamber to communicate with each other, and causes the starting fuel discharge path and the fuel return path not to communicate with the starting fuel storage chamber, respectively, and wherein, when the fuel delivery portion is not operated, the fuel supply device causes the starting fuel supply path and the starting fuel storage chamber not to communicate with each other, and causes the fuel discharge path and the fuel return path to communicate with the starting fuel storage chamber, respectively.

(6) According to a sixth aspect, there is provided the engine according to any one the first to fifth aspects, wherein the starting fuel supply path connects with the suction path.

(7) According to a seventh aspect, there is provided the engine according to any one of the first to sixth aspects, wherein the starting fuel supply device includes: a housing portion including, a fuel inflow path that connects with the fuel discharge path, a fuel outflow path that connects with the fuel return path, the starting fuel supply path, and an inner periphery wall having a circular cross-section surface, to which each of the fuel inflow path, the fuel outflow path, and the starting fuel supply path opens; and the fuel delivery portion which is provided approximately coaxial with the inner periphery wall of the housing portion and is rotatable in a circumferential direction thereof, the fuel delivery portion including, a fuel storage portion which forms the starting fuel storage chamber between the inner periphery wall, and a closing portion which closes the fuel inflow path and the fuel outflow path and causes the fuel storage portion and the starting fuel supply path to communicate with each other in a first rotation position, and causes the fuel inflow path and the fuel outflow path to communicate with the fuel storage portion and closes the starting fuel supply path in a second rotation position.

(8) According to an eighth aspect, there is provided the engine according to any one of the first to fifth aspects, wherein the starting fuel supply path connects with the cylinder bore.

(9) According to a ninth aspect, there is provided the engine according to the eighth aspect, further including: a decompression device having a decompression valve that opens and closes a decompression path which communicates with a decompression opening formed in a top dead center side of a discharge opening of the cylinder bore, wherein the starting fuel supply path connects with the cylinder bore via the decompression path and the decompression opening.

(10) According to a tenth aspect, there is provided the engine according to any one of the first to fourth aspects, wherein the starting fuel supply device includes, a first one-way valve that connects with the fuel discharge path and allows the fuel to flow from the carburetor toward the starting fuel supply device, a connection path that connects with a downstream of the first one-way valve, a division portion that connects with a downstream of the connection path and divides the connection path to a starting fuel inflow path that leads to the starting fuel supply path and a storage portion inflow path that leads to the fuel storage portion, a second one-way valve that is provided between the starting fuel inflow path and the starting fuel supply path, and allows the fuel to flow from the starting fuel inflow path toward the starting fuel supply path when a pressure difference between the starting fuel inflow path and the starting fuel supply path is equal to or higher than a predetermined value, and the fuel delivery portion including, a cylinder having an inner wall that is formed with a storage portion inflow opening which connects with the storage portion inflow path and a fuel return path opening which connects with the fuel return path, and a piston which is provided slidably in an inner portion of the cylinder, the piston forming the starting fuel storage chamber between the inner wall and causing the storage portion inflow opening and the fuel return path opening to communicate with the starting fuel storage chamber in a first sliding position, and shutting off the communication of the storage portion inflow opening and the fuel return path opening with the starting fuel storage chamber and causing the fuel in the starting fuel storage chamber to flow to the storage portion inflow path to open the second one-way valve in a second sliding position, thereby supplying the starting fuel supply path with the predetermined amount of fuel.

(11) According to an eleventh aspect, there is provided an engine operating machine including the engine according to any one of the first to tenth aspect.

This application claims priority from Japanese Patent Application No. 2010-105914 filed on Apr. 30, 2010, the entire contents of which are incorporated herein by reference.

### INDUSTRIAL APPLICABILITY

According to aspects of the present invention, there is provided an engine capable of increasing the reliability of the starting fuel supplier to more easily perform the starting operation, and an engine operating machine including the same.

1. An engine comprising:
a cylinder block formed with a cylinder bore;
a carburetor including,
a fuel storage portion that stores fuel supplied from a fuel tank via a fuel supply path and supplies the fuel to a suction path, and
a fuel discharge path that discharges fuel overflowed from the fuel storage portion;
a starting fuel supply device including,
a starting fuel storage chamber that is provided on a fuel route defined by the fuel tank and the carburetor and stores a predetermined amount of fuel,
a fuel delivery portion that delivers the fuel in the starting fuel storage chamber to a starting fuel supply path connected to the suction path or the cylinder bore, and
a fuel return path that discharges the fuel overflowed from the starting fuel storage chamber; and
a notifying portion that visually notifies that the starting fuel storage chamber is filled with fuel.

2. The engine according to claim 1,
wherein the notifying portion is a primary pump including,
a fuel absorption port to which fuel is supplied via the fuel return path,
a fuel discharge port that connects with a return path of the fuel tank, and
an operation portion that is elastically deformable and transmits light, the operation portion absorbing fuel from the fuel absorption port to an inner portion thereof and discharging the absorbed fuel to the fuel discharge port by repeating compression deformation and elastic restoration.

3. The engine according to claim 1,
wherein the notifying portion is provided so as to protrude from an engine case that covers at least a part of the cylinder block or the carburetor.

4. The engine according to claim 1,
wherein fuel is supplied to the starting fuel supply device via the fuel discharge path.

5. The engine according to claim 1,
wherein, when the fuel delivery portion for delivering the fuel to the starting fuel supply path is operated, the starting fuel supply device causes the starting fuel supply path and the starting fuel storage chamber to communicate with each other, and causes the starting fuel discharge path and the fuel return path not to communicate with the starting fuel storage chamber, respectively, and
wherein, when the fuel delivery portion is not operated, the fuel supply device causes the starting fuel supply path and the starting fuel storage chamber not to communicate with each other, and causes the fuel discharge path and the fuel return path to communicate with the starting fuel storage chamber, respectively.

6. The engine according to claim 1,
wherein the starting fuel supply path connects with the suction path.

7. The engine according to claim 1,
wherein the starting fuel supply device includes:
a housing portion including,
a fuel inflow path that connects with the fuel discharge path,
a fuel outflow path that connects with the fuel return path,
the starting fuel supply path, and
an inner periphery wall having a circular cross-section surface, to which each of the fuel inflow path, the fuel outflow path, and the starting fuel supply path opens; and
the fuel delivery portion which is provided approximately coaxial with the inner periphery wall of the housing portion and is rotatable in a circumferential direction thereof, the fuel delivery portion including,
a fuel storage portion which forms the starting fuel storage chamber between the inner periphery wall, and
a closing portion which closes the fuel inflow path and the fuel outflow path and causes the fuel storage portion and the starting fuel supply path to communicate with each other in a first rotation position, and causes the fuel inflow path and the fuel outflow path to communicate with the fuel storage portion and closes the starting fuel supply path in a second rotation position.

8. The engine according to claim 1,
wherein the starting fuel supply path connects with the cylinder bore.

9. The engine according to claim 8, further comprising:
a decompression device having a decompression valve that opens and closes a decompression path which communicates with a decompression opening formed in a top dead center side of a discharge opening of the cylinder bore,
wherein the starting fuel supply path connects with the cylinder bore via the decompression path and the decompression opening.

10. The engine according to claim 1,
wherein the starting fuel supply device includes,
a first one-way valve that connects with the fuel discharge path and allows the fuel to flow from the carburetor toward the starting fuel supply device,
a connection path that connects with a downstream of the first one-way valve,
a division portion that connects with a downstream of the connection path and divides the connection path to a starting fuel inflow path that leads to the starting fuel supply path and a storage portion inflow path that leads to the fuel storage portion,
a second one-way valve that is provided between the starting fuel inflow path and the starting fuel supply path, and allows the fuel to flow from the starting fuel inflow path toward the starting fuel supply path when a pressure difference between the starting fuel inflow path and the starting fuel supply path is equal to or higher than a predetermined value, and
the fuel delivery portion including,
a cylinder having an inner wall that is formed with a storage portion inflow opening which connects with the storage portion inflow path and a fuel return path opening which connects with the fuel return path, and
a piston which is provided slidably in an inner portion of the cylinder, the piston forming the starting fuel storage chamber between the inner wall and causing the storage portion inflow opening and the fuel return path opening to communicate with the starting fuel storage chamber in a first sliding position, and shutting off the communication of the storage portion inflow opening and the fuel return path opening with the starting fuel storage chamber and causing the fuel in the starting fuel storage chamber to flow to the storage portion inflow path to open the second one-way valve in a second sliding position, thereby supplying the starting fuel supply path with the predetermined amount of fuel.

11. An engine operating machine including the engine according to claim 1.
